(19) United States
(12) Patent Application Publication
(10) Pub. No.: US 2012/0098782 A1
(43) Pub. Date: Apr. 26, 2012

(54) TOUCH PANEL SENSOR

(76) Inventor: Dong Sik Nam, Hwaseong-si (KR)

(21) Appl. No.: 13/025,005

(22) Filed: Feb. 10, 2011

(30) Foreign Application Priority Data
Oct. 26, 2010 (KR) 10-2010-0104833

(51) Int. Cl. G06F 3/045

(52) U.S. Cl. 345/174; 178/18.06

(57) ABSTRACT

In certain embodiments, a touch panel sensor to detect a contact position of part of a body using changing of capacitance includes a lower transparent substrate that has a plurality of lower transparent electrodes aligned in parallel. The touch panel sensor also includes an upper transparent substrate that includes a plurality of upper transparent electrodes aligned in parallel to each other. The upper transparent electrodes cross over the lower transparent electrodes. A plurality of dummy transparent patterns may or may not be formed between the upper transparent electrodes. Further, two or more of the upper transparent electrodes are electrically connected at one or both of upper ends and lower ends to form a group. The portions of the upper transparent electrodes between the upper and lower ends in each group are separated from each other by a uniform width.

### CROSS-REFERENCE TO RELATED APPLICATION

This application claims the benefit of Korean Patent Application No. 10-2010-0104833, filed on Oct. 26, 2010 in the Korean Intellectual Property Office, the disclosure of which is incorporated herein by reference.

### FIELD

The present invention relates to a touch panel sensor, more particularly, relates to a touch panel sensor to detect a contact position of part of a body using changing of capacitance.

### BACKGROUND

A conventional capacitive touch panel sensor 1 is shown in FIG. 1. The conventional touch panel sensor 1 includes a lower insulation sheet 10 and an upper insulation sheet 20. On the facing surfaces of the lower insulation sheet 10 and the upper insulation sheet 20, lower ITO (Indium Tin Oxide) electrodes 30 and upper ITO electrodes 40, respectively, are formed to be intercrossed perpendicularly to each other. More specifically, the lower ITO electrodes 30 are arranged horizontally on the top of the lower insulation sheet 10, and the upper ITO electrodes 40 are arranged vertically on the bottom of the upper insulation sheet 20.

There are many intersection areas where the lower ITO electrodes 30 and the upper ITO electrodes 40 intercross, so as to generate a predetermined amount of capacitance at every intersection area. When part of a body touches the touch panel sensor 1 at least partially over the upper ITO electrodes 40, there may be a changing of the capacitance. At this time, the lower ITO electrode 30 having a relatively broad width is supplied with a frequency current to serve as a driving line, and the upper ITO electrode 40 has an electric feature that is electrically influenced replying to the frequency current. Namely, according to the approach of the body, the capacitance between the lower ITO electrode 30 and the upper ITO electrode 40 is changed, whereby the sensor can detect a body's contact position using the changing of the capacitance.

Also, in order to electrically connect the upper ITO electrode 40 and electrode 52 of an outer or external circuit substrate 50, metal lines 48 extend from the end portion of the upper ITO electrode 40 to a lower portion of the upper insulation sheet 20, and other metal lines are extended from the end portion of the lower ITO electrode 30 to be connected with the outer circuit substrate 50.

The conventional electrodes using ITO are arranged at intervals of about 5 mm and formed with a width of 300 μm or more. Because the ITO, which is transparent, has a relatively high area resistance, forming the ITO electrode thinner than about 300 μm would cause the resistance to increase sharply, which would remarkably reduce the sensitivity and reaction speed of the touch panel. Also, although ITO and IZO are transparent, it is desirable that the transparent electrodes should be formed thinly because a light passing through the electrodes is slightly distorted.

As mentioned above, ITO, IZO, carbon-nanotube (CNT), and the like are transparent generally, but they may distort light due to the difference of the index of refraction and other similar reasons. Therefore, even if the electrodes are made of the above-mentioned materials, the electrodes are not totally transparent and may distort the light due to the difference of the index of refraction.

Moreover, since the touch panel sensor is exposed to the outside of the terminal or other electric devices, the sensor may be influenced by outer electromagnetic waves. For example, even though the cause is not clearly known, the sensitivity of a signal may change slightly even if measured under the same conditions.

### SUMMARY

According to certain embodiments, the subject matter of the present disclosure provides a touch panel sensor that increases the sensitivity of the sensor when using a transparent electrode like ITO. Additionally, in certain embodiments, the subject matter of the present disclosure provides a touch panel sensor which can minimize the change of brightness and the interference of light by the existence of transparent electrodes, and reduce the deviation of measured signal sensitivity. Further, in some embodiments, the subject matter of the present disclosure provides a touch panel sensor, which can improve the reaction speed of the transparent electrodes, like ITO electrodes, and reduce the distortion of light.

According to one exemplary embodiment, a touch panel sensor, which detects a contact position of part of a body using capacitance changes, includes a lower transparent substrate including a plurality of lower transparent electrodes aligned in parallel, and an upper transparent substrate including upper transparent electrodes and dummy transparent patterns.

The upper transparent electrodes are formed in parallel crossing over the lower transparent electrodes, and may be used to detect a contact position of part of a body together with the lower transparent electrodes. Also, the dummy transparent patterns may be formed on an identical or opposite site to the upper transparent electrodes on the transparent substrate, and they are formed using conductive transparent material and are electrically separated from the upper transparent electrodes.

The dummy transparent patterns may or may not be formed with the same material as the upper transparent electrodes. The dummy transparent patterns may be formed at the area where the upper transparent electrodes do not exist on the upper transparent substrate. The dummy transparent patterns may optically compensate the space between the upper transparent electrodes, and may prevent the light passing through the sensor from being distorted.

Further, including dummy transparent patterns that are made from an electrically conductive material that is the same as or different than the upper transparent electrodes, and that are spaced between the upper transparent electrodes, maintains a signal sensitivity without deviation compared with not including dummy transparent patterns. Especially, as will be mentioned in more detail below, when two or more of the upper transparent electrodes keep a uniform line spacing to form an electrode group, the touch panel sensor may have an improved signal sensitivity. Moreover, by forming dummy transparent patterns between every upper transparent electrode, the touch panel sensor may achieve an improved signal sensitivity without deviation.

Achieving signal sensitivity with no deviation may result in the sensor detecting the body's contact rapidly and accurately when operating a program, and may result in improved speed and touch sensitivity for driving a program. Since the lower transparent electrodes are relatively wider than the upper transparent electrodes, the lower electrodes made of electrically conductive material can shield the effect of electromagnetic waves such as EMI (electromagnetic interference).

According to another exemplary embodiment, a touch panel sensor for detecting a contact position of part of a body using changing of capacitance includes a lower transparent substrate including a plurality of lower transparent electrodes aligned in parallel. The sensor also includes an upper transparent substrate including upper transparent electrodes that are electrically connected at upper ends and/or lower ends to form a group. The rest portions of the upper transparent electrodes in each group are separated from each other and maintain a uniform line spacing.

Unlike conventional single-line transparent electrodes, a plurality of the upper transparent electrodes may form a group to correspond with or replace the conventional single-line transparent electrodes. For example, with conventional sensors, the ITO electrodes have a width of about 300 μm and are placed at intervals of about 5 mm. However, according to one embodiment of the present disclosure, the ITO electrodes have a width of about 300 μm, and preferably of about 100 μm, but are positioned at uniform intervals between about 1.0 mm and 1.7 mm, with 3 to 5 of the electrodes forming a group to be aligned in parallel. Because a plurality of the upper transparent electrodes are grouped, the precise position of a finger may be calculated directly without complex computing, and the ability to rely on the finger's contact area may be applied to the touch sensing to greatly improve the sensitivity. Also, because a plurality of the upper transparent electrodes in each group is connected in parallel to decrease electric resistance, it is possible to reduce the width of the electrodes or to extend the length of the electrodes for large area display devices.

It is preferable that the upper transparent electrodes and the lower transparent electrodes are formed horizontally or vertically based on the display to cross over perpendicularly. However, in some cases, it is possible that the electrodes cross over at an angle that is not 90 degrees.

The touch panel sensor of the present disclosure, although it uses a transparent electrode such as ITO, can improve the sensitivity of the touch panel sensor, reduce the reaction time of the patterns, and decrease the distortion of light. Moreover, through the use of dummy transparent patterns, deviation of signal sensitivity at each measurement can be significantly reduced, and even almost disappear, such that the driving speed and sensitivity of a program using touch sensing may be improved.

In certain embodiments, a touch panel sensor to detect a contact position of part of a body using changing of capacitance includes a lower transparent substrate that has a plurality of lower transparent electrodes aligned in parallel. The touch panel sensor also includes an upper transparent substrate that includes a plurality of upper transparent electrodes aligned in parallel to each other. The upper transparent electrodes cross over the lower transparent electrodes. A plurality of dummy transparent patterns may or may not be formed between the upper transparent electrodes. Further, two or more of the upper transparent electrodes are electrically connected at one or both of upper ends and lower ends to form a group. The portions of the upper transparent electrodes between the upper and lower ends in each group are separated from each other by a uniform width.

In certain implementations having dummy transparent patterns, the dummy transparent patterns are made from a transparent conductive material. The dummy transparent patterns can have a width and/or a length each less than a width of each of the upper transparent electrodes. Further the dummy transparent patterns can be electrically separated from each other.

According to some implementations, a width of each of the upper transparent electrodes is less than 100 μm. The upper transparent electrodes can be formed in a shape of one of a straight line, a waved line and a folded line. In certain implementations, a metal strip is formed on at least one of the upper transparent electrodes and the lower transparent electrodes. The metal strip can be formed as a continuous strip or as a plurality of discontinuous strips.

In some implementations, the sensor includes a transparent shield layer formed on the lower transparent substrate. A metal grid can be formed on the shield layer.

According to another embodiment, a touch panel sensor includes a lower transparent substrate that includes a plurality of lower transparent electrodes aligned in parallel. The sensor includes an upper transparent substrate that includes a plurality of upper transparent electrodes aligned in parallel to each other. The upper transparent electrodes cross over the lower transparent electrodes. Two or more of the upper transparent electrodes are electrically connected at one or both of upper ends and lower ends to form a group. Portions of the upper transparent electrodes between the upper and lower ends in each group are separated from each other by a uniform width.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

The above and/or other aspects and advantages of the subject matter of the present disclosure will become apparent and more readily appreciated from the following detailed description, taken in conjunction with the accompanying drawings of which:

FIG. 1 is a perspective view to explain the conventional capacitive touch panel sensor;

FIG. 2 is an exploded perspective view to explain a touch panel sensor according to one exemplary embodiment of the present invention;

FIG. 3 is a front view to explain a upper transparent substrate of FIG. 2;

FIG. 4 is an exploded perspective view to explain the touch panel sensor according to one exemplary embodiment of present invention;

FIG. 5 is a front view to explain the upper transparent substrate of FIG. 4;

FIG. 6 is an exploded perspective view to explain a touch panel sensor according to still another exemplary embodiment of the present invention;

FIG. 7 is a front view to explain an upper transparent substrate of FIG. 6;

FIGS. 8-10 are graphs and tables illustrating the experiment results to explain the effect of the grouped upper transparent electrode separated at uniform intervals;

FIGS. 11-14, as control group, are graphs and tables illustrating the experiment results to explain the effect of the upper transparent electrode separated at not-uniform intervals;

FIG. 15 is a front view to explain an upper transparent substrate of a touch panel sensor according to another exemplary embodiment of present invention;

FIG. 16 is a cross-sectional view to explain the layer structure of a touch panel sensor according to another exemplary embodiment;

FIGS. 17 and 18 are partially enlarged views illustrating metal lines formed on transparent electrodes;

FIG. 19 is an exploded perspective view to explain a touch panel sensor according to one exemplary embodiment of this invention;

FIG. 20 is a cross sectional view to explain layer structure of the touch panel sensor; and

FIG. 21 is a perspective view to explain a shield layer of a touch panel sensor.

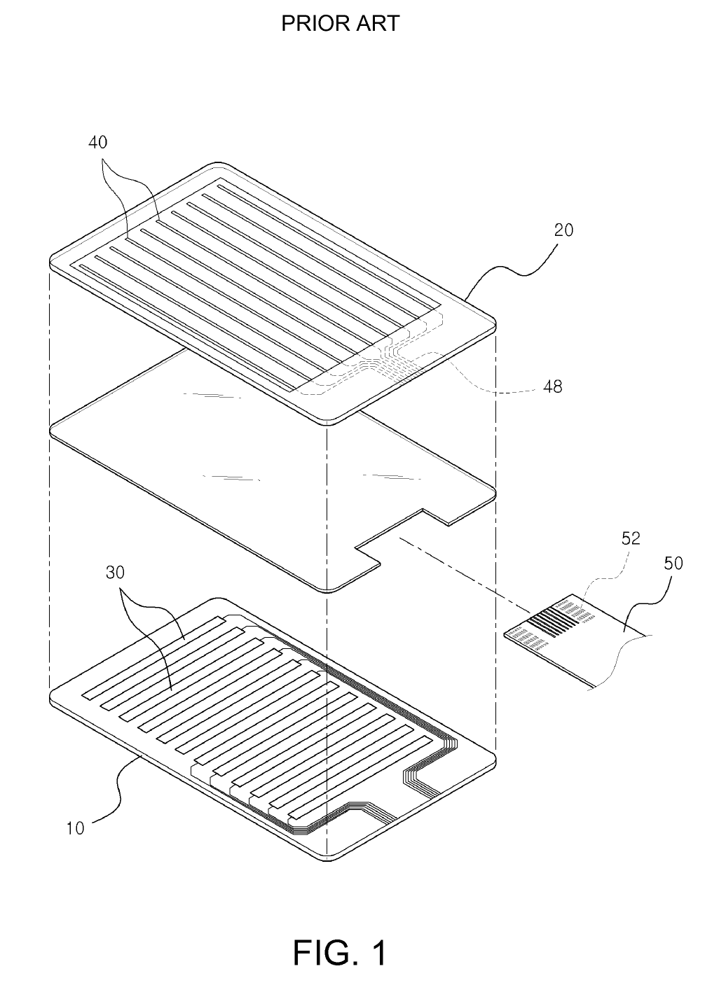

### DETAILED DESCRIPTION

Below with reference to the attached drawings, exemplary embodiments of the subject matter of the present disclosure are described in detail. However, the subject matter is not limited or restricted by any one or more exemplary embodiment of present disclosure. For reference, throughout this application, use of same number corresponds with the same element practically to utilize the explanation of content mentioned at another drawing according to this rule, and to skip obvious and repeated explanations.

Reference throughout this specification to features, advantages, or similar language does not imply that all of the features and advantages that may be realized with the subject matter of the present disclosure should be or are in any single embodiment or implementation of the subject matter. Rather, language referring to the features and advantages is understood to mean that a specific feature, advantage, or characteristic described in connection with an embodiment is included in at least one embodiment of the subject matter of the present disclosure. Discussion of the features and advantages, and similar language, throughout this specification may, but do not necessarily, refer to the same embodiment or implementation.

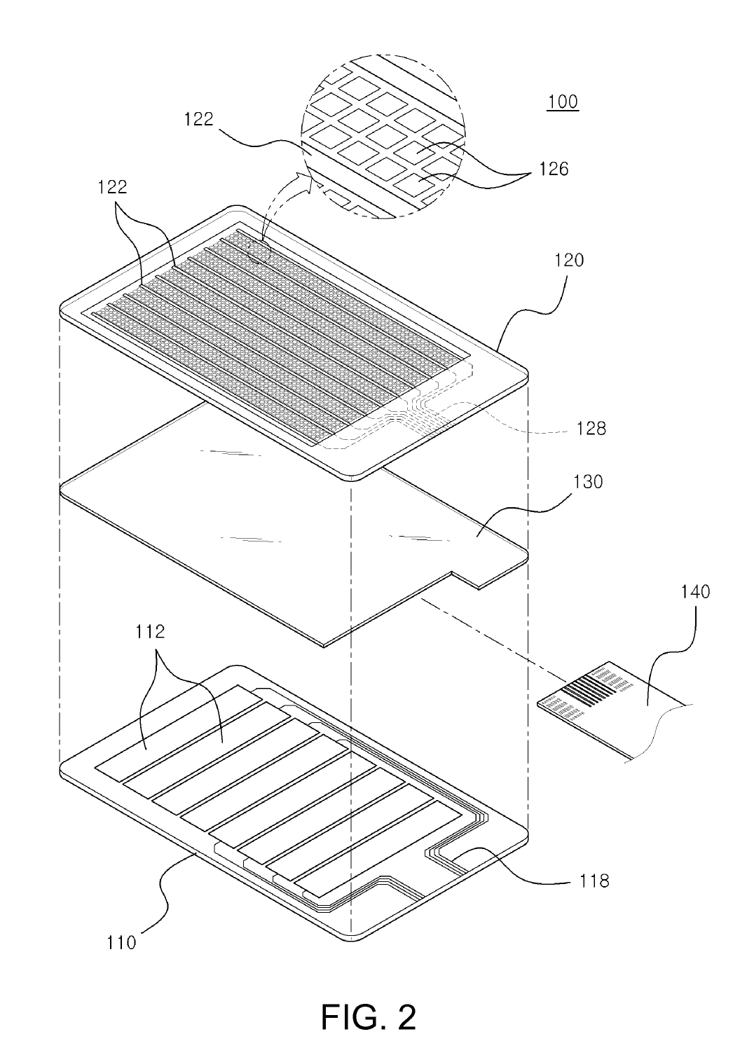

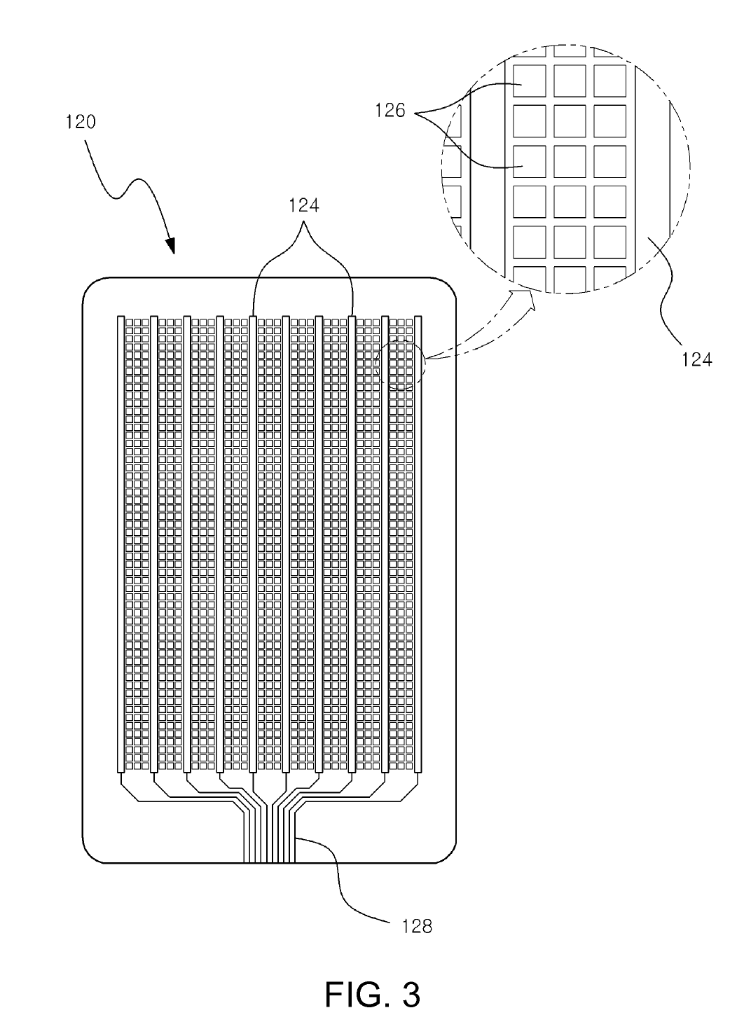

Referring to FIGS. 2 and 3, a touch panel sensor 100 includes a low transparent substrate 110 on which low transparent electrodes 112 are formed, and an upper transparent substrate 120 on which upper transparent electrodes 122 and dummy transparent patterns 126 are formed. A plurality of the lower transparent electrodes 112 may be formed to extend lengthwise in a first direction (e.g., horizontal direction) at a uniform interval on the lower transparent substrate 110. In contrast, a plurality of the upper transparent electrodes 122 may be formed to extend lengthwise in a second direction (e.g., vertical direction) that is substantially perpendicular to the first direction and formed at a uniform interval on the upper transparent substrate 120. Also, the dummy transparent patterns 126 may be formed with ITO material like the upper transparent electrodes 122 and electrically separated from the upper transparent electrodes 122.

The lower transparent substrate 110 and the upper transparent substrate 120 may be formed using a transparent dielectric film such as polyethylene terephthalate (PET), polycarbonate (PC), polypropylene (PP), polyethylene (PE) and, in some cases, at least one or both of the substrates may be formed using a glass material.

Also, an optical adhesive means 130, like OCA (Optically Clear Adhesive) film, may be supplied between the lower transparent substrate 110 and the upper transparent substrate 120, to optically adhere together the transparent substrates 110, 120. In some cases, it is possible that an optically enhanced adhesive other than a film may be used to insulate the substrates 110, 120 and bind the substrates to each other.

The lower transparent electrodes 112 are formed on a top surface of the lower transparent substrate 110, and, for example, arranged closely to each other with a width of about 0.5 mm between adjacent electrodes. It is possible to expect a screen effect of electromagnetic waves using the lower transparent electrodes 112 arranged closely to remove a noise generated from the display or the main circuit of the terminal device.

The upper transparent electrodes 122 may be formed on a bottom surface of the upper transparent substrate 120. The upper transparent electrodes 122 may also be formed using a transparent conductive material like ITO, IZO or CNT (carbon-nanotube).

The upper transparent electrodes 122 and the lower transparent electrodes 112 may be connected by connecting patterns 128 and 118, respectively, which are formed using silver paste or metal deposition, to a lower portion of the touch panel sensor. The connecting patterns 128 and 118 are electrically connected through terminal electrodes to a FPCB (flexible printed circuit board) inserted between the substrates 110 and 120. The touch panel sensor 100 may be connected to external main controller through the FPCB 140 to transfer touch signals generated by the interaction of the transparent electrodes.

The dummy transparent patterns 126 may be provided regularly or irregularly between the upper transparent electrodes 122, and be electrically separated from each other. The dummy transparent patterns 126 may be formed from material having an equal or similar refractive index to the upper transparent electrodes 122, so as to prevent the light from being distorted. Also, if the dummy transparent patterns 126 are formed from conductive materials, they can shield the inside of the transparent electrodes 122 and 112 from noise directed from the outside of the upper transparent substrate 120, to form a stable field between the electrodes 122 and 112 and keep a constant signal sensitivity without variation.

The dummy transparent pattern 126 may be formed with a size equal to or smaller than the width of the upper transparent electrodes 122. In this embodiment, the width and length of the dummy transparent pattern 126 are substantially equal to the width of the upper transparent electrode 122. The dummy transparent patterns may be elongated, i.e. vertically elongated, having a width thinner than the upper transparent electrode 122. However, as shown, it is preferable that the dummy transparent patterns 126 are separated all around for stable signal sensitivity. If the dummy transparent patterns 126 are formed larger or wider than the upper transparent electrodes 122, the dummy transparent patterns 126 overlaid by the body may affect the surrounding upper transparent electrodes 122, which are not overlaid with the body. Therefore, it is desirable that the dummy transparent patterns 126 are smaller and more densely packed than the upper transparent electrodes 122. In this embodiment, the upper transparent electrodes 122 and the dummy transparent patterns 126 are formed using the same material and on the same surface on the substrate 120. However, the electrodes 122 and the patterns 126 may be formed using different materials and on opposite surfaces.

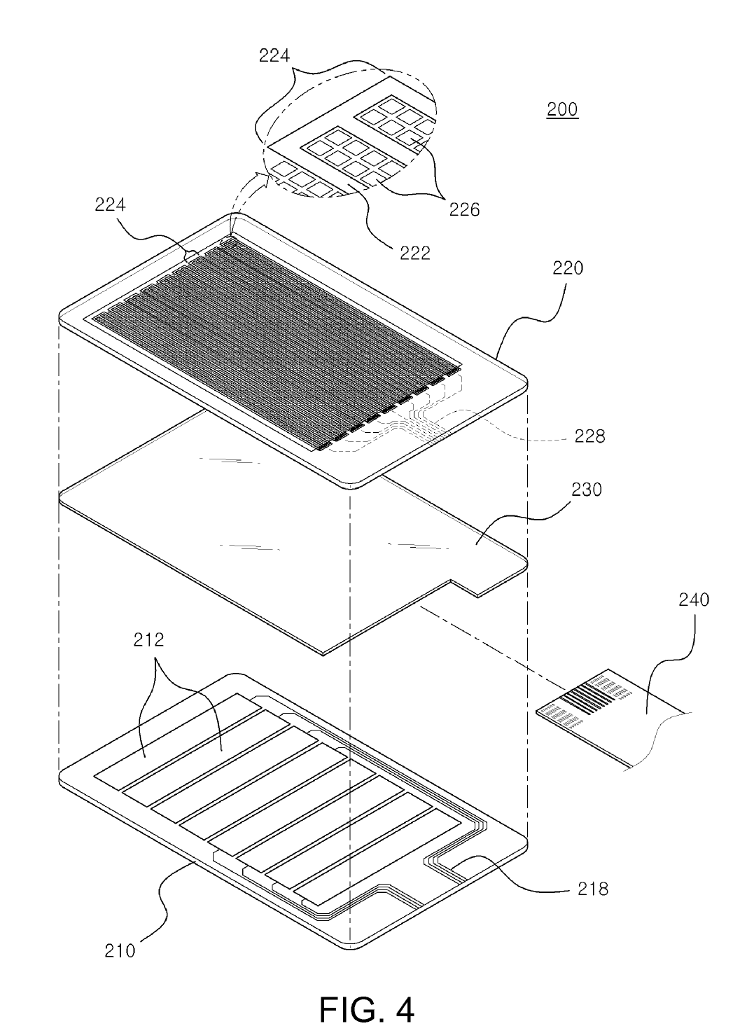

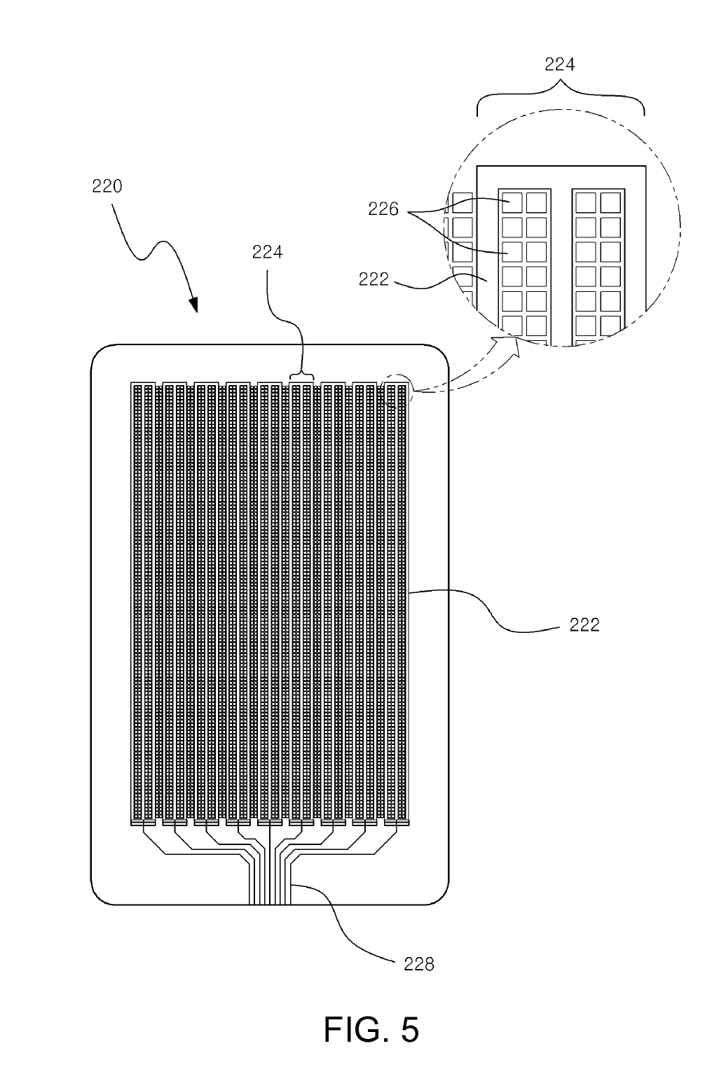

Referring to FIGS. 4 and 5, a touch panel sensor 200 includes a lower transparent substrate 210 on which lower transparent electrodes 212 are formed, and an upper transparent substrate 220 on which upper transparent electrodes 222 are formed. Dummy transparent patterns 226 are formed between the upper transparent electrodes 222. In this embodiment, three of the upper transparent electrodes 222 which are adjacent to each other form one electrode group 224, in which top and bottom ends of the electrodes are connected electrically in each group. In some cases, only one of the top and bottom ends may be connected electrically. The lower transparent substrate 210 and the upper transparent substrate 220 may be formed using transparent dielectric film or glass, and an optical adhesive means 230, like OCA film, may be supplied between the lower transparent substrate 210 and the upper transparent substrate 220.

The lower transparent electrodes 212 may be formed on a top surface of the lower transparent substrate 210, and the upper transparent electrodes 222 may be formed on a bottom surface of the upper transparent substrate 220. The upper transparent electrodes 222 and the lower transparent electrodes 212 may be formed from transparent conductive material, such as ITO and IZO, in which three or more than of the upper transparent electrodes 222 may compose one group 224 to be electrically connected.

Also, in this embodiment, the dummy transparent patterns 226 may be provided regularly or irregularly between the upper transparent electrodes 222, and they may be formed with a size equal to or smaller than the width of the upper transparent electrodes 222. Each of the dummy transparent patterns 226 may be formed substantially in the shape of a square or rectangle, and in some cases, in any of various shapes, such as, for example, circle, triangle, diamond, hexagon, etc. The dummy transparent pattern 226 may be formed with conductive material and can block out noise from outside of the upper transparent electrodes 222. Further, because they form a stable field between the upper transparent electrodes 222 and the lower transparent electrodes 212, the dummy transparent patterns 226 can help providing a constant signal sensitivity without deviation.

The dummy transparent pattern 226 may be formed with a size equal to or smaller than the width of the upper transparent electrodes 222. In this embodiment, the width and length of the dummy transparent pattern 226 are substantially equal to the width of each upper transparent electrode 222. The dummy transparent patterns 226 may be formed with a smaller size so as not to disrupt interactions between the upper and the lower transparent electrodes 222 and 212. Also, it is desirable that the dummy transparent patterns 226 are smaller and more densely packed than the upper transparent electrodes 222.

A group 224 of the upper transparent electrodes 222 may induce the change of more enhanced capacitance may be induced, whereby the enhanced capacitance change can further increase the sensitivity of touch panel sensor. Actually, as using the grouped upper transparent electrodes 222, the sensitivity of the touch panel sensor can be improved.

Also, should a plurality of the upper transparent electrodes 222 be formed with a width of equal or less than about 300 μm, three or more than of the transparent electrodes are grouped and connected in parallel, so as to reduce the resistance. Desirably, it is possible to form the upper transparent electrodes 222 with widths of about 100 μm or less. Accordingly, the upper transparent electrodes 222, which are parallel to each other and separated at a uniform line spacing, can detect the finger's position precisely.

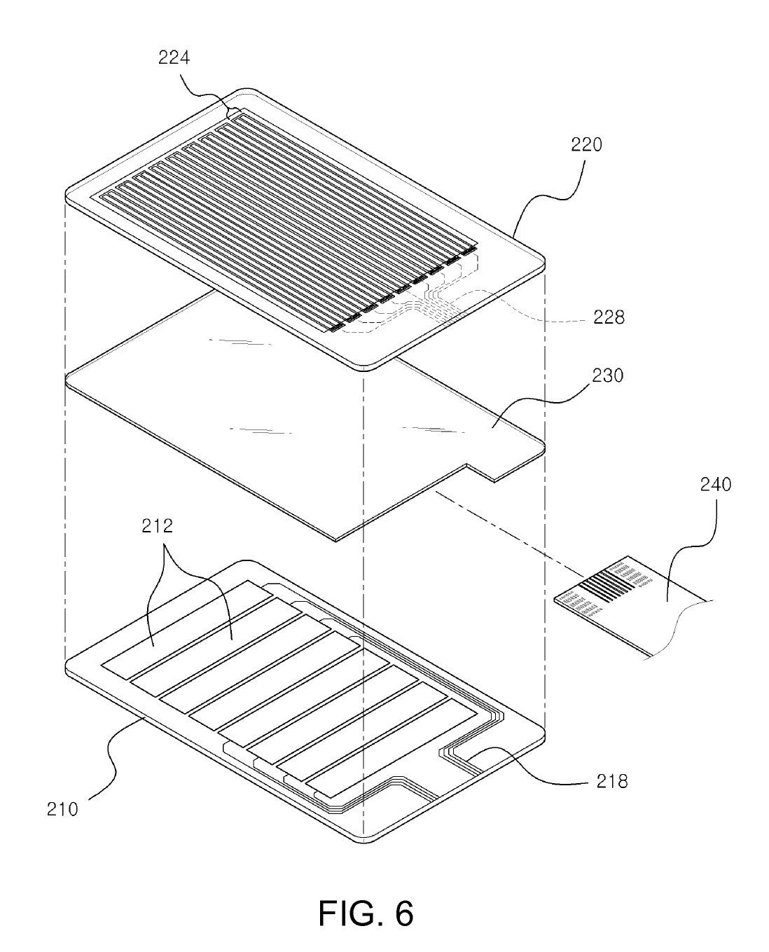

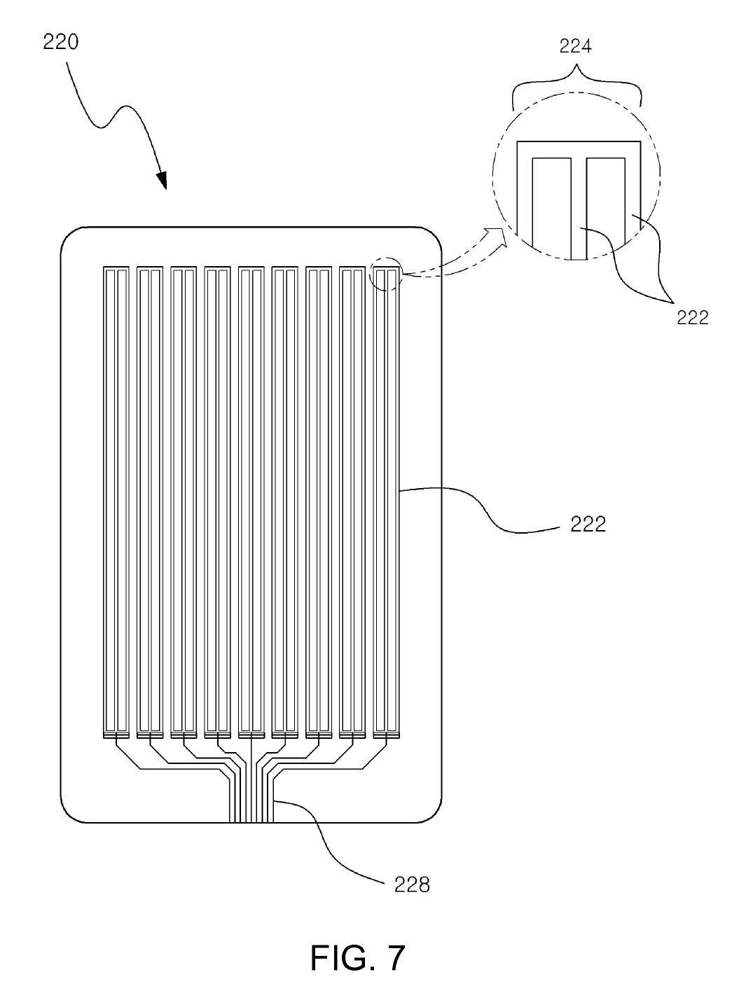

Referring to FIGS. 6 and 7, a touch panel sensor includes a lower transparent substrate 210 on which low transparent electrodes 212 are formed, and an upper transparent substrate 220 on which upper transparent electrodes 222 are formed. Unlike the previous embodiment of FIGS. 4 and 5, there are no dummy transparent patterns between the upper transparent electrodes 222.

In this embodiment, three of the upper transparent electrodes 222, which are adjacent to each other, form one electrode group 224, in which top and bottom ends of the electrodes are connected electrically in each group. In some cases, only one of the top and bottom ends may be connected electrically. Compared to having dummy transparent patterns, the touch panel sensor in this embodiment may have a relatively high deviation, and may also have a high signal sensitivity compared to the sensor using the ungrouped electrodes.

The lower transparent substrate 210 and the upper transparent substrate 220 may be formed of dielectric transparent films or glass, and an optical adhesive means 230, like OCA film, may be supplied between the lower transparent substrate 210 and the upper transparent substrate 220. The lower transparent electrodes 212 may be formed on a top surface of the lower transparent substrate 210, and the upper transparent electrodes 222 may be formed on a bottom surface of the upper transparent substrate 220. The upper transparent electrodes 222 and the lower transparent electrodes 212 may be formed using transparent conductive material, such as ITO and IZO, in which three or more than of the upper transparent electrodes 222 may compose one group 224 to be electrically connected.

A group 224 of the upper transparent electrodes 222 may induce an increase in the enhanced capacitance, whereby the enhanced capacitance change can further increase the sensitivity of touch panel sensor. Actually, grouping the upper transparent electrodes 222 as shown and described, the sensitivity of the touch panel sensor can be improved.

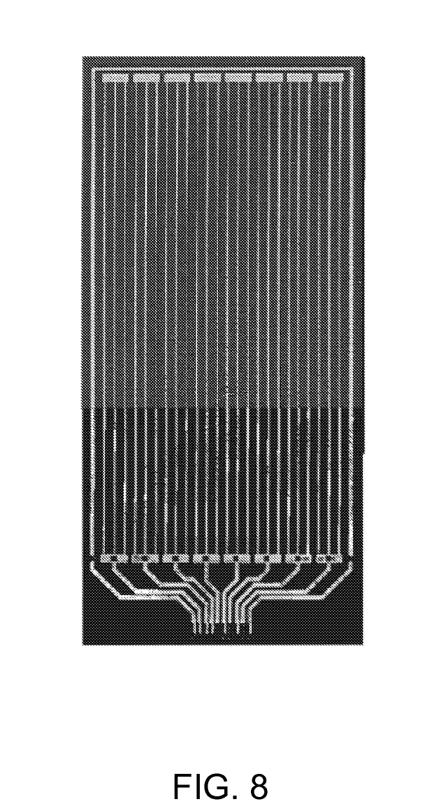

Control studies were conducted on upper plates with various upper electrode group patterns (e.g., at uniform and non-uniform intervals). The experimental results obtained from the control studies were used to explain the effect of grouping upper transparent electrodes separated by uniform intervals versus grouping upper transparent electrodes separated by non-uniform intervals. Each of FIGS. 8-14 shows one of the various upper electrode group patterns used to obtain the experimental results.

Referring to FIG. 8, where each group is composed of three strands of micro-transparent electrodes, the upper transparent electrodes are arranged uniformly by an interval of about 1.633 mm with each electrode having a width of about 0.1 mm. In this case, the SNR was about 43, which was relatively higher than those of the conventional sensors. For reference, SNR means a signal-to-noise ratio, wherein the higher the SNR, the more precise the value measured by the sensor, without noise. Therefore, the value of the SNR may be a criterion for improving the speed of touch sensing. For example, when the SNR is high, the speed of touch sensing is also high.

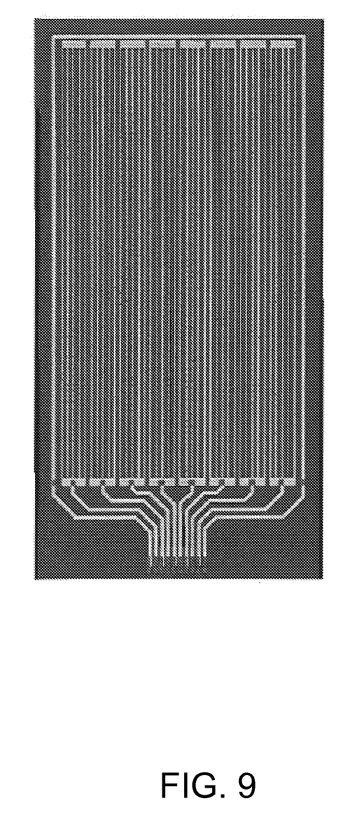

Referring to FIG. 9, where each group is composed of five strands of micro-transparent electrodes, the upper transparent electrodes are arranged uniformly by an interval of about 0.98 mm. In this case, the SNR was between about 42 and about 45, which is relatively higher than those of the conventional sensors.

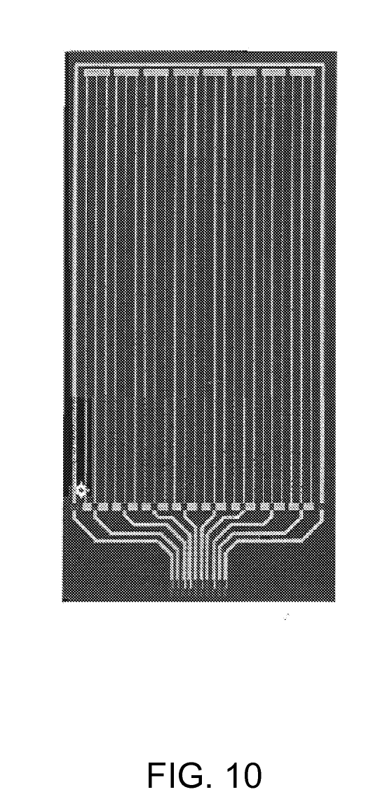

Referring to FIG. 10, where each group is composed of three strands of micro-transparent electrodes, the transparent electrodes are arranged uniformly by an interval of about 1.633 mm. However, the width of the transparent electrodes was about 0.15 mm, which is relatively larger than that of the patterns of FIG. 8. In this case, the SNR was between about 42 and about 46, which was relatively high.

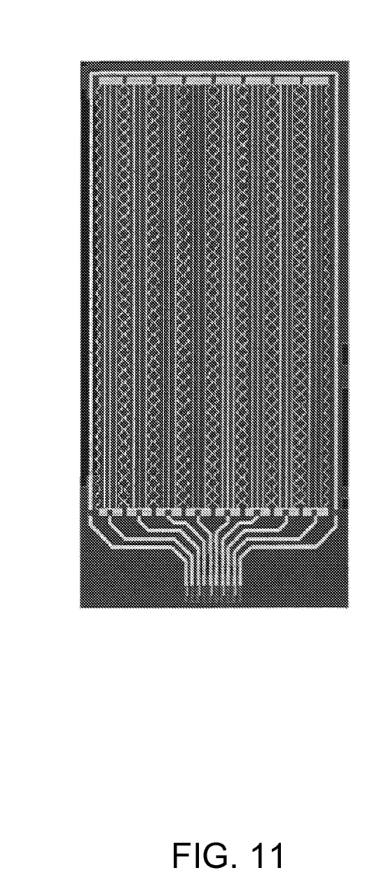

Referring to FIG. 11, where each group is composed of five strands of micro-transparent electrodes, the intervals of the patterns are not uniform (e.g., intervals of 0.98 mm, 1.4 mm, 0.6 mm, and 1.9 mm). The micro-transparent electrodes are provided in a mixed state where waved lines and straight lines are mixed. In this case, the SNR was about 20 (e.g., about half of the result associated with the substrates of FIG. 8 to FIG. 10) which was low.

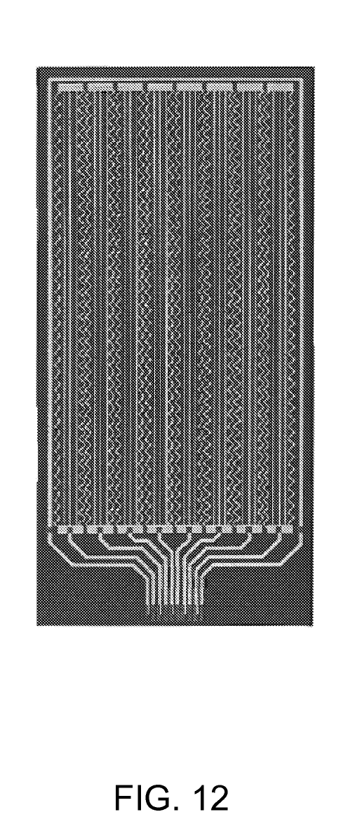

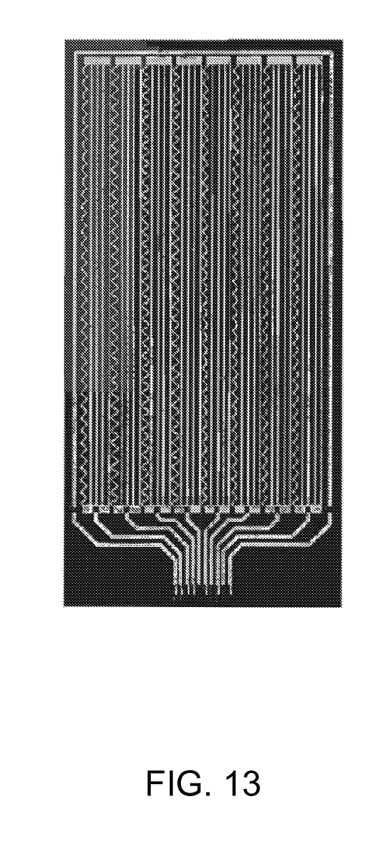

Referring to FIGS. 12 and 13, where each group is composed of five strands of micro-transparent electrodes, the intervals of the patterns are not uniform (e.g., intervals of 0.98 mm, 1.4 mm, and 0.6 mm), and the micro-transparent electrodes are provided in a mixed state where waved lines and straight lines are mixed. FIG. 12 has three straight electrodes and two waved electrodes per group. FIG. 13 has four straight electrodes and one waved electrode per group. In this case, the SNR for the substrates represented in both FIGS. 12 and 13 was between about 20 and about 22, which was relatively low.

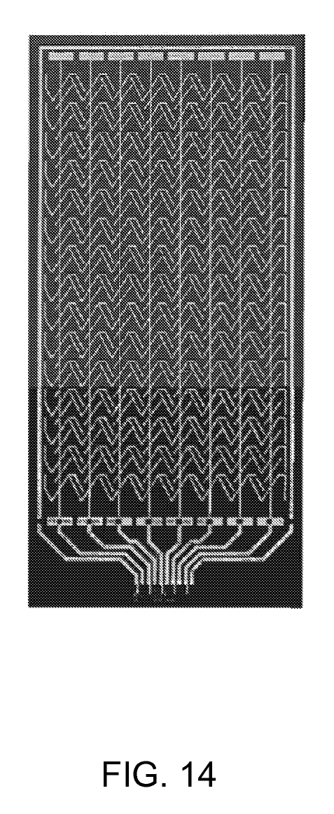

Referring to FIG. 14, where one transparent electrode expands widely and partially intersects with another adjacent transparent electrode, the distance between the transparent electrodes is not uniform. In this case, the SNR was between about 25 and about 29, which was much lower than that obtained for the substrates associated with FIG. 8 to FIG. 10.

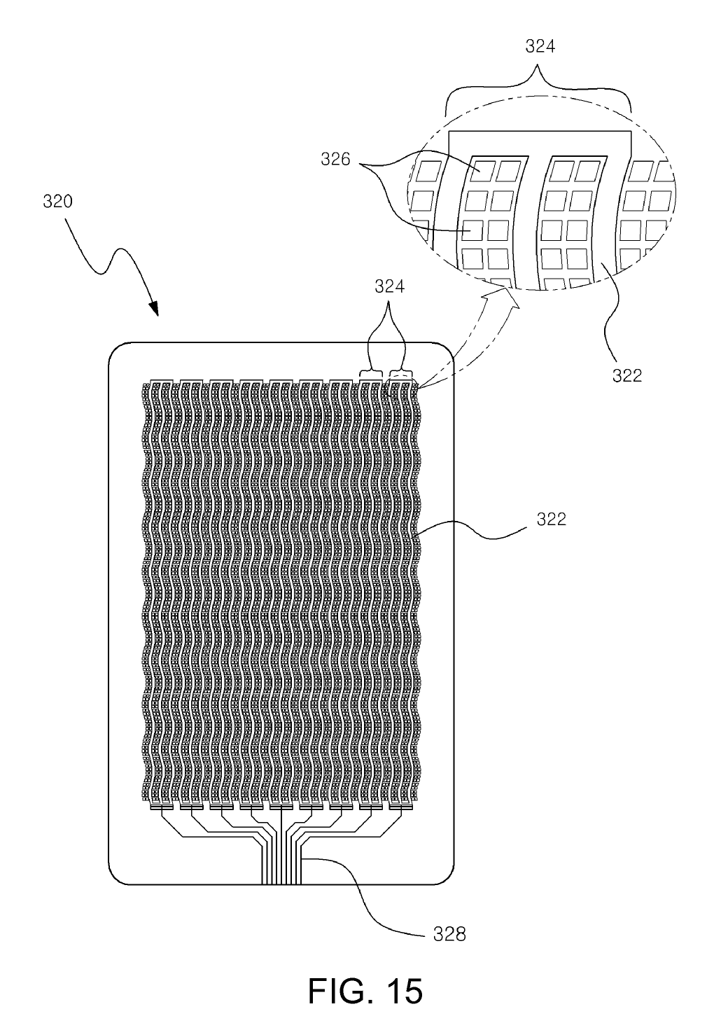

Referring to FIG. 15, a plurality of upper transparent electrodes 322 are formed vertically in a shape of waved line on an upper transparent substrate 320, and dummy transparent patterns 326 which are separated from each other are formed between every upper transparent electrode 322. A plurality, for example three, of the upper transparent electrodes 322 form one electrode group 324, of which the top and the bottom ends are electrically connected. In this embodiment, the upper transparent electrodes 322 are formed in a waved line shape, otherwise they may be formed in a repeatedly folded line shape.

In case that the upper transparent electrodes 322 are formed in a waved line, each electrode has a greater contact area for capacitance than a straight line. Since the change of the capacitance occurs along a relatively longer path, the wave transparent electrode 322 has an improved sensitivity compared to a straight electrode. The dummy transparent patterns 326 can prevent a light from being distorted, and, because of the low amount of SNR, the dummy patterns can help the touch panel sensor have a substantially constant signal sensitivity without deviation.

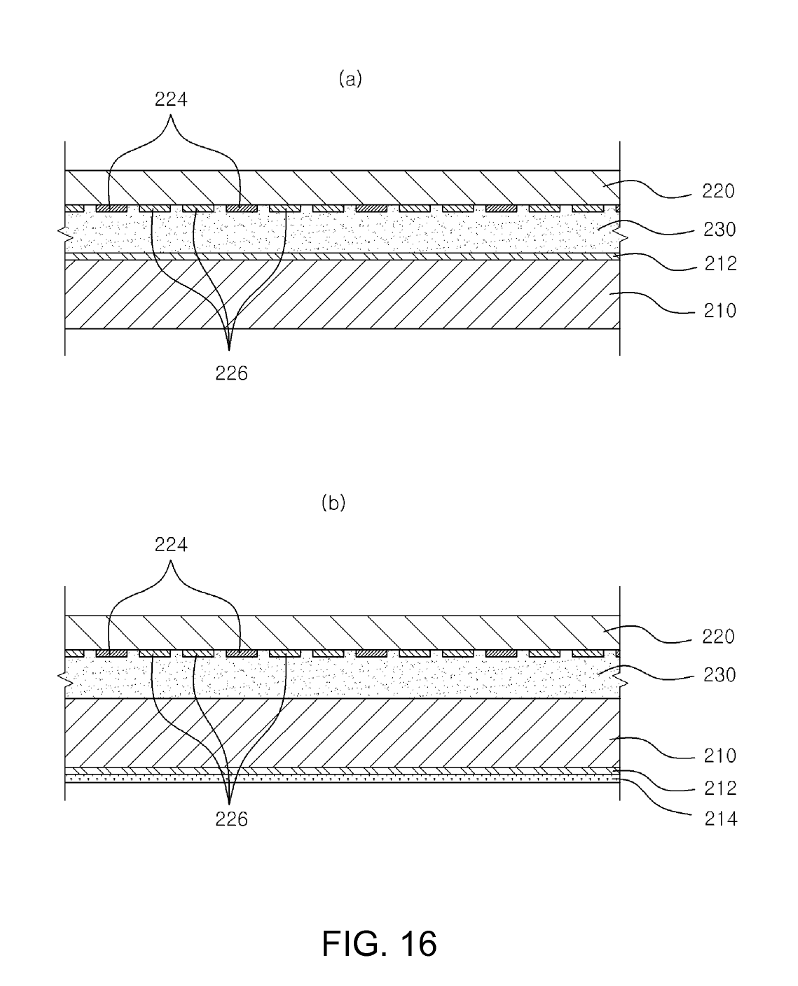

For reference, the structure and interaction of the touch panel sensor of FIG. 16 can refer to the structure and the description about the touch panel sensor of FIG. 4 and FIG. 5. Referring to FIG. 16(a), the lower transparent electrodes 212 of the lower transparent substrate 210 face against the upper transparent electrodes 224 and the dummy transparent patterns 226 of the upper transparent substrate 220. However, referring to FIG. 16(b), the lower transparent electrodes 212 are formed on the bottom of the lower transparent substrate 210, whereas the upper and dummy transparent electrodes 224, 226 are formed on the bottom of the upper transparent substrate 220. In case of forming the lower transparent electrode 212 on the bottom of the lower transparent substrate 210, a protection film 214 or protection layer may be formed on the bottom of the lower transparent electrode 212.

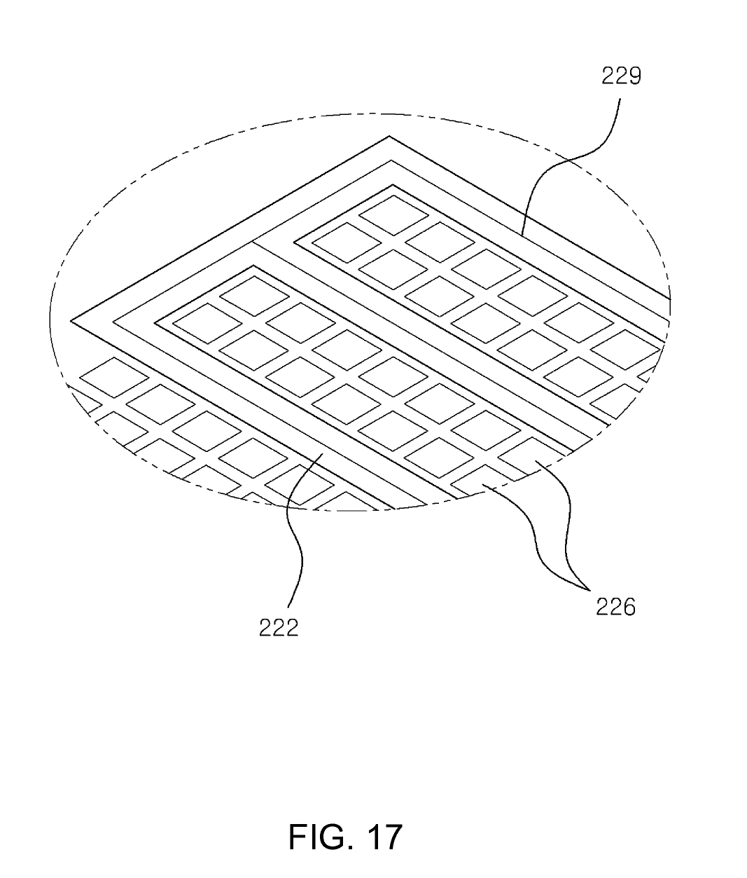

Referring to FIG. 17, a metal line 229 may be formed on the upper transparent electrode 222 with a width of less than about 30 μm. The metal line 229 may be formed on the top or the bottom of the transparent electrodes, and help current flow more easily because of its low resistance compared with the transparent electrode. Since the horizontal and vertical lengths of the screen in a large area display area relatively long, the resistance of the transparent electrodes in that display may be relatively high. But, through use of the metal line 229, the total resistance of the transparent electrode and the metal line is decreased. Also, the metal line 229 may be formed using metal, such as aluminum, tungsten, corresponding alloys, and the like, and may be formed by various methods, such as deposition, inkjet printing, silkscreen, photoresist, and the like. The metal line 229 may be formed with a width of about 30 μm as discussed above, but may preferably have a width of about 10 μm so as to be effectively invisible (e.g., invisible to the human eye) from outside the display. Further, to achieve effective invisibility, the metal line 229 may be formed using dark colored metal or may be blinded using an anti-reflection layer or a diffusion layer, to prevent light from being mirror reflected.

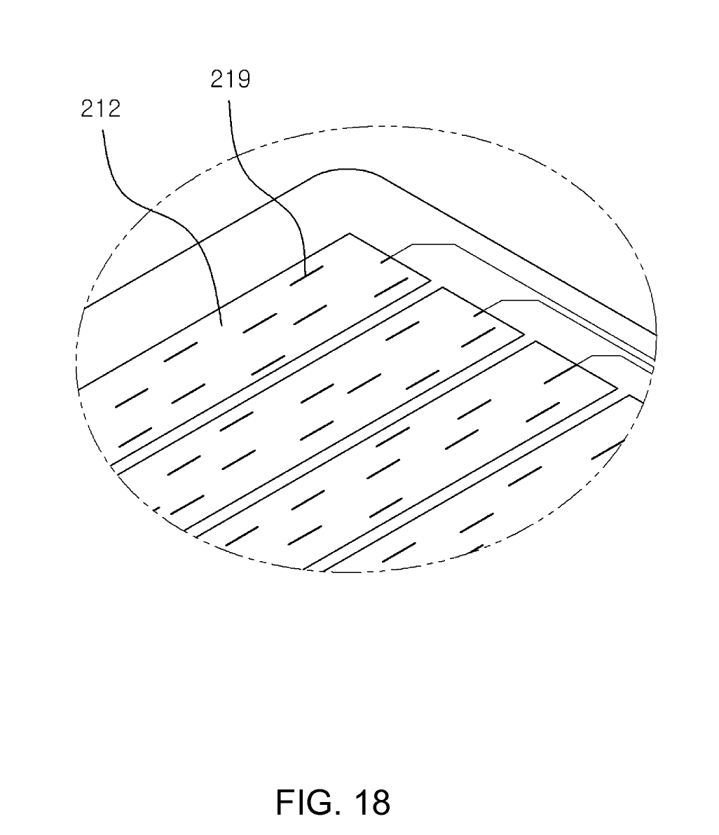

Referring to FIG. 18, a plurality of metal lines 219 may be formed on the top or the bottom of the lower transparent electrodes 212 to decrease the resistance of the transparent electrodes. As shown, the metal lines 219 are formed discontinuously and arranged irregularly on the transparent electrode. Of course, the discontinuous and/or irregular metal lines may likewise be formed on the upper transparent electrodes 222.

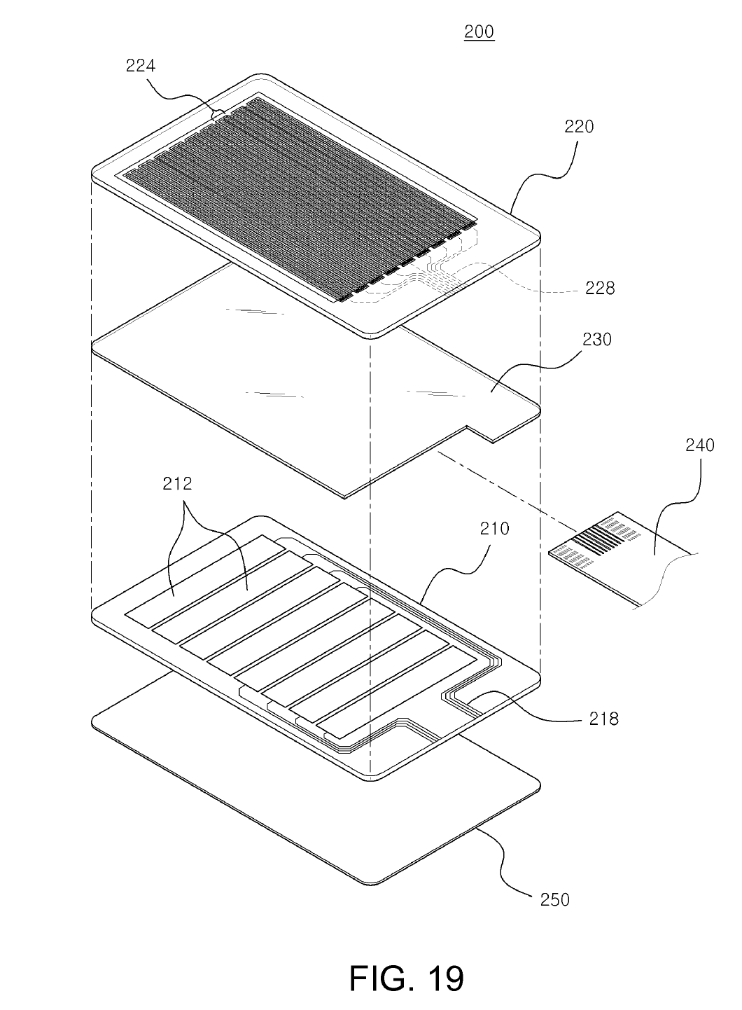

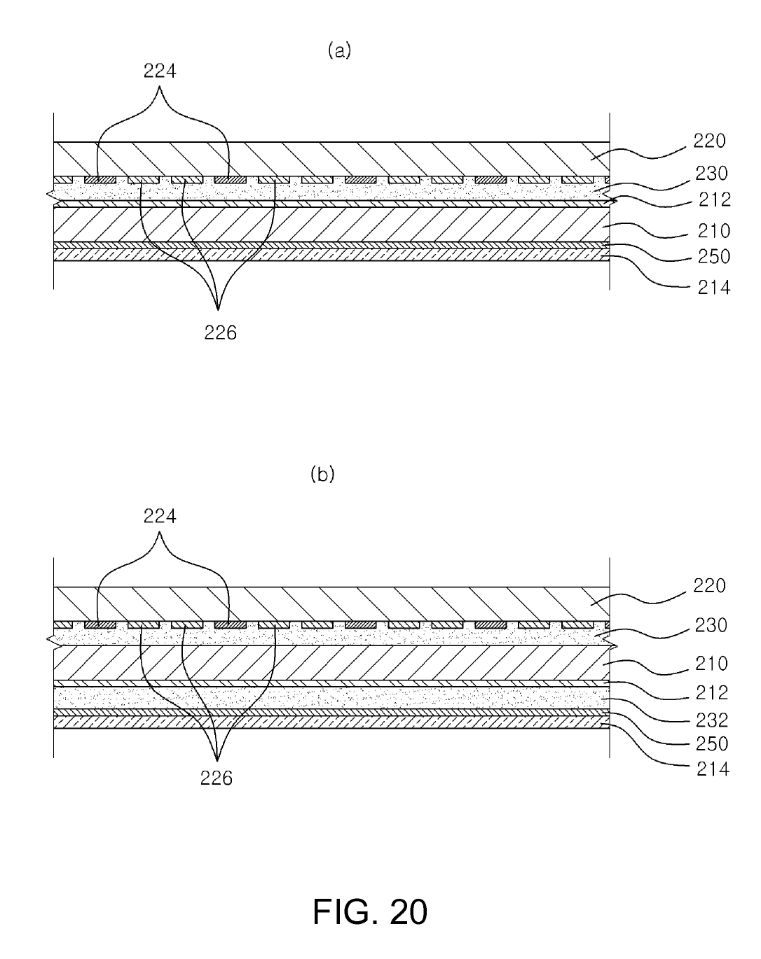

Referring to FIGS. 19 and 20, a shield layer 250 may be formed beneath the lower transparent electrodes 212. The shield layer 250 may be used to blind noise from below the touch screen, may be formed using transparent conductive material, and may be earthed. Referring to FIG. 20(a), the shield layer 250 may be formed on the bottom of the lower transparent substrate 210, and a protection layer 214 may be on the bottom of the shield layer 250. In the case that the lower transparent electrode 212 is formed on the bottom of the substrate 210 (see, e.g., FIG. 20(b)), an optical adhesive layer 232, like OCA, the shield layer 250 and a protection layer 214 may be formed in order.

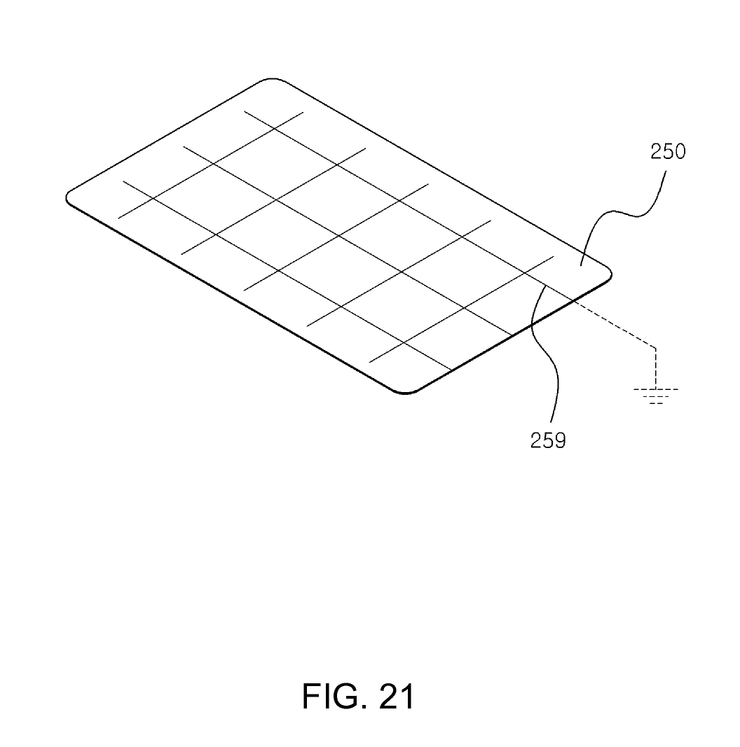

As shown in FIG. 21, a metal grid 259 may be formed on the shield layer 250. The metal grid 259 may be formed continuously or discontinuously on the shield layer 250 to give the layer 250 a uniform electric property.

The subject matter of the present disclosure may be embodied in other specific forms without departing from its spirit or essential characteristics. The described embodiments are to be considered in all respects only as illustrative and not restrictive. The scope of the subject matter of the present disclosure is, therefore, indicated by the appended claims rather than by the foregoing description. All changes which come within the meaning and range of equivalency of the claims are to be embraced within their scope.

What is claimed is:

1. A touch panel sensor to detect a contact position of part of a body using changing of capacitance, comprising:
a lower transparent substrate comprising a plurality of lower transparent electrodes aligned in parallel; and
an upper transparent substrate comprising a plurality of upper transparent electrodes aligned in parallel to each other, the upper transparent electrodes crossing over the lower transparent electrodes, and a plurality of dummy transparent patterns formed between the upper transparent electrodes;
wherein two or more of the upper transparent electrodes are electrically connected at one or both of upper ends and lower ends to form a group, wherein the portions of the upper transparent electrodes between the upper and lower ends in each group are separated from each other by a uniform width.

2. The touch panel sensor of claim 1, wherein the dummy transparent patterns are made from a transparent conductive material.

3. The touch panel sensor of claim 1, wherein the dummy transparent patterns have a width and a length each less than a width of each of the upper transparent electrodes, and wherein the dummy transparent patterns are electrically separated from each other.

4. The touch panel sensor of claim 1, wherein the dummy transparent patterns have a width that is less than a width of each of the upper transparent electrodes, and wherein the dummy transparent patterns are electrically separated from each other.

5. The touch panel sensor of claim 1, wherein a width of each of the upper transparent electrodes is less than 100 μm.

6. The touch panel sensor of claim 1, wherein the upper transparent electrodes are provided in a shape of one of a straight line, a waved line and a folded line.

7. The touch panel sensor of claim 1, wherein a metal strip is formed on at least one of the upper transparent electrodes and the lower transparent electrodes.

8. The touch panel sensor of claim 7, wherein the metal strip is formed continuously or discontinuously.

9. The touch panel sensor of claim 1, further comprising a transparent shield layer formed on the lower transparent substrate.

10. The touch panel sensor of claim 9, wherein a metal grid is formed on the shield layer.

11. A touch panel sensor to detect a contact position of part of a body using changing of capacitance, comprising:
a lower transparent substrate comprising a plurality of lower transparent electrodes aligned in parallel; and
an upper transparent substrate comprising a plurality of upper transparent electrodes aligned in parallel to each other, the upper transparent electrodes crossing over the lower transparent electrodes;
wherein two or more of the upper transparent electrodes are electrically connected at one or both of upper ends and lower ends to form a group, wherein the portions of the upper transparent electrodes between the upper and lower ends in each group are separated from each other by a uniform width.

12. The touch panel sensor of claim 11, wherein a width of each of the upper transparent electrodes is less than 100 μm.

13. The touch panel sensor of claim 11, wherein the upper transparent electrodes are provided in a shape of one of a straight line, a waved line and a folded line.

14. The touch panel sensor of claim 11, wherein a metal line is formed on at least one of the upper transparent electrodes and the lower transparent electrodes.

15. The touch panel sensor of claim 14, wherein the metal line is formed continuously or discontinuously.

16. The touch panel sensor of claim 11, further comprising a transparent shield layer formed beneath the lower transparent substrate.

17. The touch panel sensor of claim 16, wherein a metal grid is formed on the shield layer.

18. A touch panel sensor to detect a contact position of part of a body using changing of capacitance, comprising:
a lower transparent substrate comprising a plurality of lower transparent electrodes aligned in parallel; and
an upper transparent substrate comprising a plurality of upper transparent electrodes aligned in parallel to each other, the upper transparent electrodes crossing over the lower transparent electrodes, and a plurality of dummy transparent patterns formed between the upper transparent electrodes;
wherein two or more of the upper transparent electrodes are electrically connected at one or both of upper ends and lower ends to form a group.
